(19) United States
(12) Patent Application Publication
(10) Pub. No.: US 2001/0044756 A1
(43) Pub. Date: Nov. 22, 2001

(54) Payroll deduction system and method including provision for financing and dispute resolution

(75) Inventors: Kirk E. Watkins, Warrington, PA (US); Timothy R. Myers, Willow Street, PA (US)

Correspondence Address: MORGAN, LEWIS & BOCKIUS, 1800 M STREET NW, WASHINGTON, DC, 20036-5869, US

(73) Assignee: e-Duction, Inc.

(21) Appl. No.: 09/907,426

(22) Filed: Jul. 18, 2001

Related U.S. Application Data
(63) Continuation-in-part of application No. 09/429,616, filed on Oct. 29, 1999.

(51) Int. Cl. G06F 17/60

(52) U.S. Cl. 705/26

(57) ABSTRACT

A method of dynamically resolving disputes between an employee using a payroll deduction plan to pay for purchases and an external system processing the payroll deduction plan, the method comprising the steps of (a) determining if the dispute relates to a product or service purchased from a merchant or to an error in the processed employee payroll deduction; (b) if the dispute relates to an error in the processed employee payroll deduction, determining if the error is related to a number of deduction periods or the employee's pay cycle frequency; (c) if the error relates to an error in the number of deduction periods, the external system corrects the number of deduction periods and determines if a next payroll deduction period is in progress of being processed; (d) if the external system determines that a deduction period is in progress, the external system allows the next deduction to occur and determines if the deduction amount is too high or too low; (e) if the deduction amount is too low, the employee payroll deduction amounts are increased per deduction period; (f) if the deduction amount is too high, the external system allows the employee to choose to immediately receive a cash refund or to have future payroll deduction amounts adjusted; and (g) if the dispute relates to an error in the employee's pay cycle frequency, the external processing system updates and corrects the employee pay cycle frequency in the payroll deduction plan and determines if the next payroll deduction period is in progress and if so, performs steps (d) through (f).

This application is a continuation of application Ser. No. 09/429,616, filed on Oct. 29, 1999, application Ser. No. 09/497,142 filed on Feb. 3, 2000, application Ser. No. 09/691,191, filed on Oct. 19, 2000, and application Ser. No. 09/670,016 filed on Sep. 26, 2000.

### FIELD OF THE INVENTION

The present invention relates to a system and method for processing payments of articles selected during electronic commerce or off-line commerce, and more particularly, to a method for using an automatic deduction as a payment option during on-line and off-line commerce that includes a scheme for financing to the customer and a method for resolving purchase, deduction, and/or financing disputes.

### BACKGROUND OF THE INVENTION

Some employers currently offer, as a benefit to their employees, payroll deduction plans as a method of paying for predetermined products and/or services with predetermined vendors. Under existing payroll deduction plans, the employer may deduct the cost of already purchased articles and/or services from an employee's future pay checks. Before the employee can use the payroll deduction plan as a payment option, the employer must approve the total purchase amount and the vendor. While this scheme affords employees the option of purchasing products and services on future earnings, the list of predefined products/services and vendors is usually limited. Moreover, the payroll deduction payment option is not utilized in electronic commerce nor is the payroll deduction payment option utilized for regular purchases during non-electronic commerce.

Furthermore, the existing payroll deduction schemes offer no financing capabilities. Unrelated methods of financing for customers exist today, such as a credit card wherein the customer pays a financial institution interest for the convenience of extending payments for products purchased. Unfortunately, the interest rates charged by some financial institutions are very high. A customer easily can pay over twice the purchase price of the product if payment for the product stretches over years. This type of financing is contradictory to the employee payroll deduction-type commerce in that the employee's financial well being simply is not protected.

When a customer purchases a product using any type of credit card or through a payroll deduction plan, the ability to return products for credit or to dispute the charges made to the customer usually is quite difficult. With “traditional” credit cards, the customer must contact the card company, usually in writing, and wait for the determination that a credit is warranted. This sometimes takes months to process. If an employee who is having monies deducted from a paycheck disputes a deduction, at least one more pay period after the dispute is initiated must cycle through before the employee is reimbursed.

Thus, a system and method is needed to both finance payroll deduction payment plans and to easily and quickly resolve disputes a customer/employee may have with purchases and charges.

### SUMMARY OF THE INVENTION

Accordingly, the present invention is directed to a payroll deduction system and method including provisions for financing and dispute resolution that substantially obviates one or more of the problems due to limitations and disadvantages of the related art.

The present invention relates to a system and method for using an e-duction card as a payment instrument, whereby the purchase price of articles purchased on-line or off-line is deducted from an employee's paycheck. The e-duction card is similar to a credit card but is not bound by the same terms and conditions of a credit card in that an employee/customer may pay for products over a certain period of time without incurring any interest payments.

Another object of the present invention is to provide a method and system that allows customers a virtually unlimited base of products to purchase without incurring any interest, and that allows customers to be able to make recurring purchases without incurring interest payments.

Another object of the present invention is to provide a method and system that allows customers to easily dispute a purchase or payroll deduction amount and, if successful, receive a refund or credit, perhaps immediately.

Additional features and advantages of the invention will be set forth in the description that follows, and in part will be apparent from the description, or may be learned by practice of the invention. The objectives and advantages of the invention will be realized and attained by the system particularly pointed out in the written description and claims hereof as well as the appended drawings.

To achieve these and other advantages and in accordance with the purpose of the invention, as embodied and broadly described, the present invention provides a method for selecting and processing account deductions as a payment option between pre-selected vendors and an employee of an employer, the method comprising the steps of authorizing, by the employee, an external processing system to perform account deductions as a payment option during commerce between the pre-selected vendors and the employee; establishing, by the external processing system and the employer, guidelines for an account deduction plan; storing the guidelines in the external processing system database; selecting, by the employee, articles to be purchased from at least one of the pre-selected vendors; storing, by the external processing system into the database, at least one electronic order of the articles to be purchased; sending, by the employer, instructions to deposit the employee's pay into an account for the employee; and dynamically processing, by the external processing system, instructions to the employee's account to transfer a payment amount to the external processing system based upon the at least one electronic order and the guidelines.

An alternate embodiment of the present invention provides a system a method for allowing an employee of an employer to place an order with a plurality of vendors, comprising (a) establishing guidelines for an account deduction plan by an external processing system and the employer, wherein the account deduction plan allows qualified employees of the employer to automatically pay for orders placed with any of the plurality of vendors using the account deduction plan; (b) receiving electronically, at the external processing system, order information from one of the plurality of vendors with whom a purchasing employee wishes to place an order; (c) determining electronically by the external processing system, in response to the order information and in accordance with the account deduction plan guidelines and the qualification information, whether to automatically approve or reject the order; and (d) if the order is approved, electronically processing by the external processing system, instructions to the employee's account to transfer a payment amount to the vendor based upon the one electronic order and the guidelines.

An alternate embodiment of the present invention provides a method of dynamically resolving disputes between an employee using a payroll deduction plan to pay for purchases and an external system processing the payroll deduction plan, the method comprising the steps of (a) determining if the dispute relates to a product or service purchased from a merchant or to an error in the processed employee payroll deduction; (b) if the dispute relates to an error in the processed employee payroll deduction, determining if the error is related to a number of deduction periods or the employee's pay cycle frequency; (c) if the error relates to an error in the number of deduction periods, the external system corrects the number of deduction periods and determines if a next payroll deduction period is in progress of being processed; (d) if the external system determines that a deduction period is in progress, the external system allows the next deduction to occur and determines if the deduction amount is too high or too low; (e) if the deduction amount is too low, the employee payroll deduction amounts are increased per deduction period; (f) if the deduction amount is too high, the external system allows the employee to choose to immediately receive a cash refund or to have future payroll deduction amounts adjusted; and (g) if the dispute relates to an error in the employee's pay cycle frequency, the external processing system updates and corrects the employee pay cycle frequency in the payroll deduction plan and determines if the next payroll deduction period is in progress and if so, performs steps (d) through (f).

In yet another embodiment, the present invention provides a method for selecting and processing account deductions as a payment option between a plurality of vendors and an employee of an employer, the method comprising the steps of authorizing, by the employee, an external processing system to perform account deductions as a payment option during commerce between the plurality of vendors and the employee; establishing, by the external processing system and the employer, guidelines for an account deduction plan; storing the guidelines in the external processing system database; selecting, by the employee, articles to be purchased from at least one of the plurality of vendors; storing, by the external processing system into the database, at least one electronic order of the articles to be purchased; sending, by the employer, instructions to deposit the employee's pay into an account for the employee; and dynamically processing, by the external processing system, instructions to the employee's account to transfer a payment amount to the external processing system based upon the at least one electronic order and the guidelines.

In another embodiment, the present invention provides A method of dynamically resolving disputes between an employee using a payroll deduction plan to pay for purchases and an external system processing the payroll deduction plan, the method comprising the steps of (a) determining if the dispute relates to a merchant purchase or to an error in the transaction processing; (b) if the dispute relates to a merchant purchase, determining if the dispute is related to a product or to delivery of a service; (c) if the dispute relates to a product, determining if the product was returned to the merchant, and if so, determining if the merchant refused to accept the returned product or otherwise provide relief to the employee; (d) if the dispute relates to a service, determining if the service was fully received by the employee, and if not, determining a partial refund to the employee is possible, and if so, determining if the merchant refused to provide a partial refund or otherwise provide relief to the Employee; (e) if the dispute relates to an error in transaction processing, determining if the error is related to merchant and/or card processor posting of the transaction or if the error is related to automatic deductions executed by the external system; (f) if the dispute relates to merchant and/or card processor posting of the transaction, determining if the employee has documentation to support the dispute; (g) if the dispute relates to an error in the automatic deductions executed by the external system, determining if the dispute relates to an automatic payroll deduction from an incorrect employee, an error in a repayment period, an error in payroll cycle frequency, or an error in a total amount deducted for a single transaction; (h) if the dispute relates to steps (c) through (g) above, determining if automatic payroll deductions have already occurred, or if not, determining if automatic payroll deductions are already in process; (i) if automatic deductions in (h) above have already occurred or are in the process of occurring, and if the dispute relates to steps (f) and (g), determining if the transaction processing error resulted in an automatic payroll deduction more than or less than a correct amount; Q) if the dispute relates to steps (c) and (d), or if the automatic deduction in step (i) is determined to be more than the correct amount, correcting the automatic payroll deduction; (k) if the dispute relates to step (i) and the automatic payroll deduction is more than the correct amount, allowing the employee to choose to have immediate reimbursement; (1) if the automatic payroll deduction in step (i) is less than the correct amount, correcting future the automatic payroll deductions by extending a repayment period; (m)deferring all future automatic payroll deductions until the dispute is finally resolved; (n) if the dispute is finally resolved in the employee's favor, eliminating all future automatic payroll deductions entirely; and (o) if the dispute is partially resolved in the employee's favor or if the dispute is resolved in the external system's favor, reinstating all remaining automatic payroll deductions as scheduled and recovering deducted amounts that were reimbursed to the employee in steps (j) and (k).

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates a method for using an e-duction card as a payroll deduction instrument during on-line or off-line purchases;

FIGS. 2 and 2A illustrate the steps implemented according to a preferred embodiment of the inventive method of FIG. 1.

FIG. 3 illustrates the steps implemented according to an alternate embodiment of the present invention.

FIG. 4 illustrates the steps implemented for financing a payroll deduction plan according to a preferred embodiment of the inventive method;

FIG. 5 illustrates the steps implemented for another embodiment of financing a payroll deduction plan.

FIGS. 6-6C illustrate the steps implemented in a dispute resolution according to a preferred embodiment of the inventive method.

### DESCRIPTION OF THE PREFERRED EMBODIMENTS

Reference will now be made in detail to the preferred embodiments of the present invention, examples of which are illustrated in the accompanying drawings. The present invention described below describes the functionality of the inventive system and method for processing payroll deduction by using an e-duction card, resolving disputes, and financing the payments.

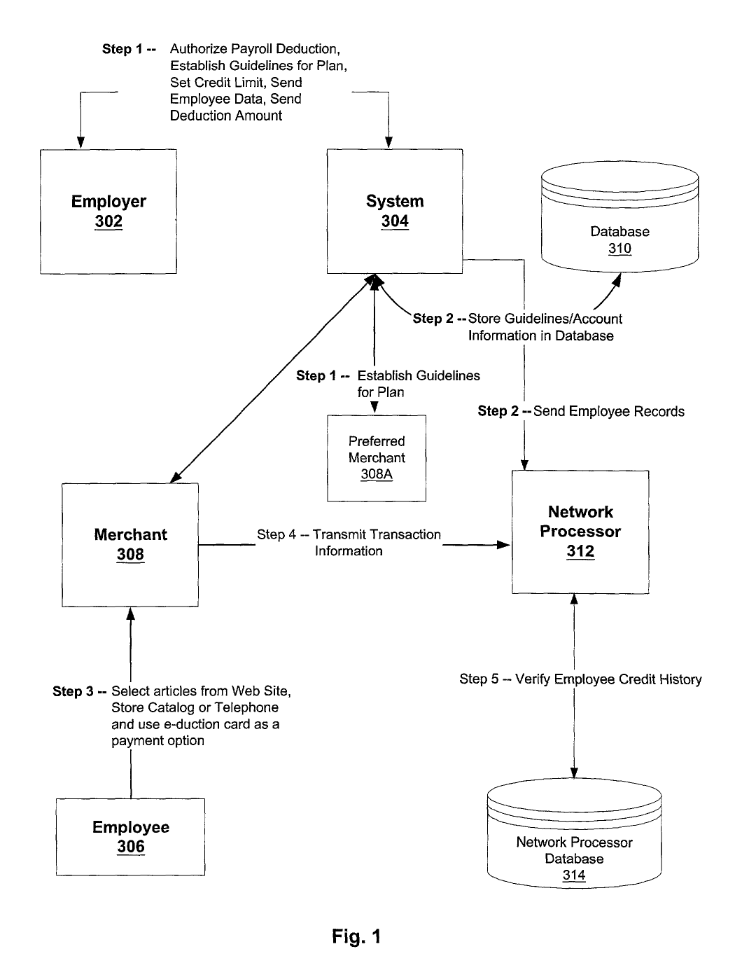

FIG. 1 illustrates an inventive method for using an e-duction card as a payment instrument in order to deduct the price of a purchased item from an employee's future paycheck. According to the invention, an employee 306 authorizes employer 302 to process payroll deduction, as calculated in system 304, as a unique form of payment during a commerce transaction with the employer's employees. System 304 also enables a user to purchase products using the e-duction card from merchants 308 who agree to accept the e-duction card as a payment instrument. The e-duction card is thus treated by merchants 308 as simply another type of credit card from any issuer. During the initial authorization, employer 302 and/or system 304 representative establish guidelines for a payroll deduction plan. For example, employer 302 and/or system 304 representative may establish a maximum balance that an employee may carry on the e-duction card and the length of the repayment period over which deductions can occur for a specific purchase. They also may base the length of the repayment period and therefore the number of payroll deductions on the type of transaction, purchase and/or merchant. For example, a deduction amount (that is based on the debt balance of the e-duction card) that is less than forty-nine dollars and ninety nine cents may be deducted from one future paycheck; a deduction that is greater than fifty dollars and less than ninety-nine dollars and ninety nine cents may be deducted from two future paychecks, and so on. Of course, as the e-duction debt balance changes each payroll period, the deductions also change each payroll period to reflect payments made and new purchases made.

To participate in the payroll deduction plan, employee 306 fills out an application form. The information on the application form is entered into an enrollment database on system 304 and system 304 verifies employee 306 eligibility status by confirming employee 306 employment status and income, among others. The enrollment database also stores guidelines established by system 304 and/or employer 302. For example, a guideline in the enrollment database may establish that employee 306 must be employed for a predefined length of time, for example six months, in order to participate in the payroll deduction plan. In anther example, a guideline in the enrollment database may establish a maximum credit limit for payroll deduction, for each employee 306, that is based on a percentage of employee 306 gross annual pay. In yet another example, employees may be grouped in different enrollment plans, depending on employee annual gross pay, employment positions, etc. The credit limit for purchases for all employees in a given enrollment plan could thus be based on a percentage of the gross annual pay of those particular employees.

During the enrollment process, employee 306 may also choose to sign up for an overdraft line of credit. To approve the overdraft line of credit, network processor 312 checks employee 306 credit report. Upon approval of the overdraft line of credit, if employee 306 purchases an item that costs more than the maximum e-duction card credit limit, the extra amount is charged to employee 306 overdraft account. Payment terms for the e-duction account and optional credit line account are calculated differently. Thus, for example, the amount for the e-duction card account is deducted from future paychecks and the amount for the optional credit line account may be paid as a regular interest bearing credit card account, with minimum monthly payroll deduction terms defined by network processor 312. This type of financing will be discussed in greater detail below.

Upon receiving an application for the e-Duction card from employee 306, system 304 transmits the information to employer 302 for verification. Employer 302 verifies employee 306 personnel information, such as name, social security number, employment status, annual salary, and length of employment. Upon receiving a verification notice from employer 306, system 304 stores the employee 306 information in a applicant database, determines qualification status of each employee 306 stored, and transmits a record for each employee 306 (whether qualified or non-qualified for approval) to a network processor 312.

In an alternate embodiment of the invention, the verification may be automated by synchronizing a periodic list of all employees from employer 302 with information in the enrollment database. System 304 may use the periodic list (which includes updates regarding all employees and information regarding new employees) to re-evaluate eligibility for each employee 306. For example, if employee 306 received a two-percent raise, upon obtaining the list system 304 recalculates employee 306 maximum e-duction card credit limit. In another example, system 304 may use the periodic list to cancel accounts of employees who are no longer on the list.

Employer 302 and system 304 representative also may establish several sets of guidelines, whereby each set is associated with employees 306 within a specific status. For example, one set of guidelines may apply to hourly employees 306 and another set may apply to salaried employees 306. Employees 306 may view all guidelines that apply to them and guidelines associated with each employee 306 may change as the employee's status changes. As would be obvious to one skilled in the art, system 304 may include unique guidelines for each participating employer 302 and/or employee 306.

During initial setup, system 304 also may set up guidelines with preferred merchants 308. For example, a merchant 308 may be authorized to offer interest free payroll deductions up to a predefined extended time for payments over a certain amount. Service merchants, such as utility companies and investment companies 308 also may enroll in the system 304 program. Thus, employees 306 authorized to use payroll transactions for such transactions can have automatically deducted periodic, for example monthly, payments for utility bills and investments. The payroll deduction plan guidelines and other information that identify employer 302 and corresponding employees 306 are stored on a system database 310 in system 304.

As is apparent to one skilled in the art, a merchant who already accepts an issuer's credit card that signs up with the inventive system may not have to sign up to participate in system 304 in order to accept the e-duction issuer's card.

Thereafter, when an employee selects articles from the merchant's 308 web site or store, employee 306 may use the e-duction card to pay for the selected articles. Additionally, an employee may use the e-duction card in commerce in any similar fashion as any type of credit card is used. For example, employee 306 may use the e-duction card when purchasing items from a catalog, through telemarketing, offers appearing on television, etc. Other methods of purchase will be known to those skilled in the art and are within the scope of this invention.

The e-duction card used is similar to a credit card, but is not bound by the same terms and conditions of a credit card. For example, employees using the e-duction card might not be charged interest or some types of transaction fees to use the e-duction card. The e-duction card may be executed on its own network infrastructure or on existing network infrastructures, such as an American Express® network infrastructure or a Visa®/Mastercard® network infrastructure. Existing networks issue private brand cards, which carry the network's logo. Thus, an e-duction card may be a private brand that is executed on an existing network infrastructure and looks the same as currently used credit card, such as American Express® card and Visa® card, among others. Of course, the e-duction may not necessarily carry the network's logo.

Employees 306 may use the e-duction card as a payment instrument for articles purchased on-line or in a store. When an employee 306 chooses articles to be purchased from a merchant 308, merchant 308 may swipe the employee 306 e-duction card in an existing network infrastructure. Alternatively, employee 306 may ‘enter’ the merchant's 308 web site and upon selecting articles to be purchased, enter the account number of the e-duction card on the merchant's web site, or may select items from a catalog and enter the account number of the e-duction card on a form or over the telephone. Other commerce transactions are known to those skilled in the art and are within the scope of this invention.

When the e-duction card is swiped into the network infrastructure, account information that is stored on the e-duction card's magnetic stripe is transmitted to network processor 312. Network processor 312 may be a processor used in an existing network infrastructure and account information stored in system database 310 also is stored in the network processor's database 314. Network processor 312 uses the account information and information stored in the processor's database 314 to verify the employee's eligibility and available credit limit. Network processor 312 also checks the available e-duction card limit and optional credit line for employee 306 against the amount of the purchase and performs standard risk management checks. If the purchase amount is less than the available credit, network processor 312 approves the transaction and transmits an approval code to merchant 308. Upon verifying employee 306 and merchant 308 information, network processor 312 may approve or reject the transaction. Alternatively, the e-duction card may be swiped into it's own network infrastructure and system 304 may verify employee 306 and merchant 308 account information and approve or reject the transaction.

Network processor 312 initiates payment for the amount of the transaction to merchant 308, less a discount rate paid by merchant 308. Thereafter, at a predefined time, network processor 312 transmits a transaction file with all transactions to system 304. Based on the guidelines in system database 310, system 304 calculates installment payments for each transaction in the transaction file. The installment payments are deducted from future paychecks. While calculating installment payments for each transaction, system 304 checks a merchant identifier in the transaction file to determine if the associated merchant 308 is a preferred merchant. If merchant 308 is a preferred merchant, system 304 applies the payment guidelines that were previously established for that merchant to transactions associated with that merchant, including eligibility for extended credit terms. System 304 sends the preferred merchant 308 a periodic bill that is preferably based on a percentage of associated transactions or other criteria.

Prior to the next pay period, system 304 generates a deduction file with the installment payments for each employee from whom a payroll deduction should be made. The deduction file contains records listing each employee name, social security number, employer name and identifier and the amount to be deducted from the upcoming paycheck. As is apparent, other information may be listed in the deduction file, and are within the scope of the invention. The deduction files are then transmitted to appropriate payroll processors at predetermined times. For example, at the end of a work week, accounts in system database 310 for those employees with outstanding installment payments are sent to payroll processor, including employees with remaining payments for pervious purchases and including employees making new purchases for which this is their first payment.

Based on employee 306 account information in system database 310, system 304 can determine who is employee's 306 employer, and which payroll processor processes the employee 306 paychecks (some employers use paycheck processing companies to process their payroll and other employers perform this task themselves). Thus, either the employer 302 deducts the specified amount from employee 306 paycheck; or alternatively, if a payroll processing company is used, that company deducts the appropriate amount from the employees' next paycheck and notifies system 304 and employer 302 about the success or failure of each deduction for each employee. System 304 updates employee 306 account in system database 310 in order to reflect the payment. A statement notifying employee 306 of the payroll deduction may be sent to employee 306 prior to the payroll deduction. Employee 306 also may access a system web site to review a purchasing history. Thus, employee 306 may review all payroll deductions for all articles purchased within a predefined period of time. When employee 306 receives the next paycheck, the installment payment will be deducted from the paycheck. The employer 302 initiates an electronic funds transfer to transfer the total amount for all deductions for all employees for that pay period to a bank account associated with network processor 312. The system 304 coordinates these payments to network processor 312 to credit the correct employee accounts.

In an alternate embodiment of the invention, the e-duction card may include a chip that stores employee 306 account information and purchasing history, thereby functioning as a smart card. Information in the chip may include, among other things, employee 306 account number, employer, and payroll deduction status. Information in the e-duction card chip is updated after each transaction to reflect the transaction.

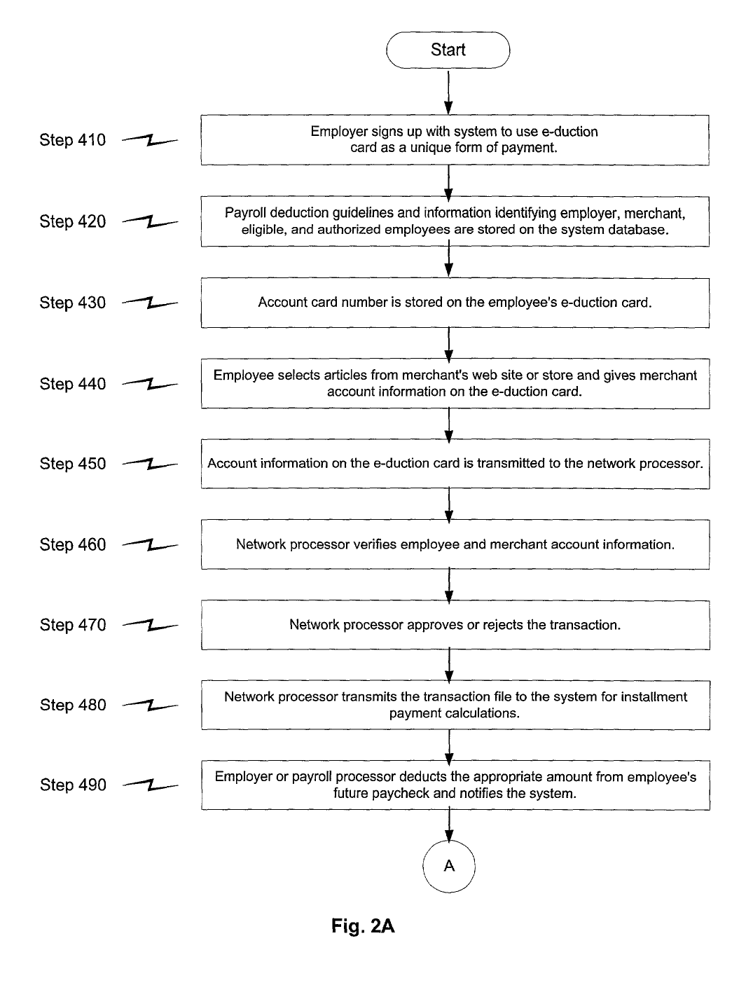

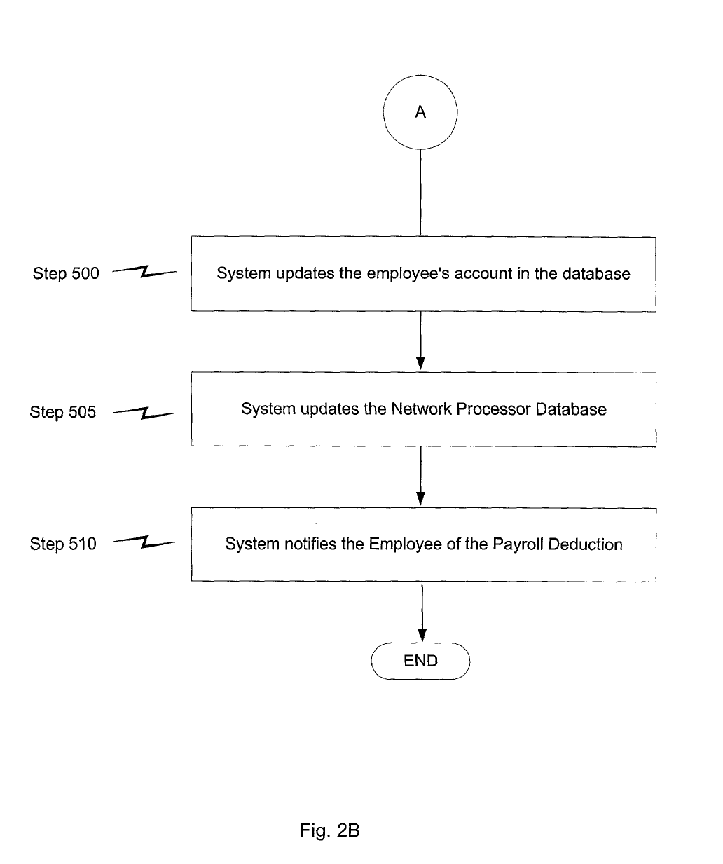

FIG. 2A illustrates the steps implemented in a preferred embodiment of the inventive payroll deduction method. In Step 410, employer 302 signs up with system 304 to use the e-duction card as a unique form of payment during a commerce transaction with the employer's employees. Merchant 308 also may register with the system to become a participating merchant. System 304 and participating merchant 308 establish guidelines for a payroll deduction plan.

In Step 420, the payroll deduction plan guidelines and other information that identify employer 302, merchant 308, and corresponding employees 306 are stored on a system database 310 in system 304. In Step 430, account information is stored on employee 306 e-duction card. In Step 440, employee 306 selects articles from the merchant's 308 web site or store, swipes the e-duction card in a network infrastructure or enters an account number on the e-duction card on the merchant's web site. In Step 450, account information that is stored on the e-duction card's magnetic stripe is transmitted to network processor 312. In Step 460, network processor 312 uses the account information and information stored in database 314 to verify employee's eligibility and available credit limit. In Step 470, network processor 312 may approve or reject the transaction.

In Step 480, network processor 312 transmits the transaction file to system 304 for installment payment calculations. In Step 490, the deduction file is transmitted from system 304 to the payroll processor and the payroll processor deducts the appropriate amount from employee 306 future paychecks and notifies system 304. In Step 500, system 304 updates employee 306 account in system database 310 in order to reflect the payment, and similarly updates, in step 505, database 314 in network processor 312. In Step 510, a statement notifying employee 306 of the payroll deduction is sent to the employee through the mail, an e-mail, or by the employee accessing a web site containing the information.

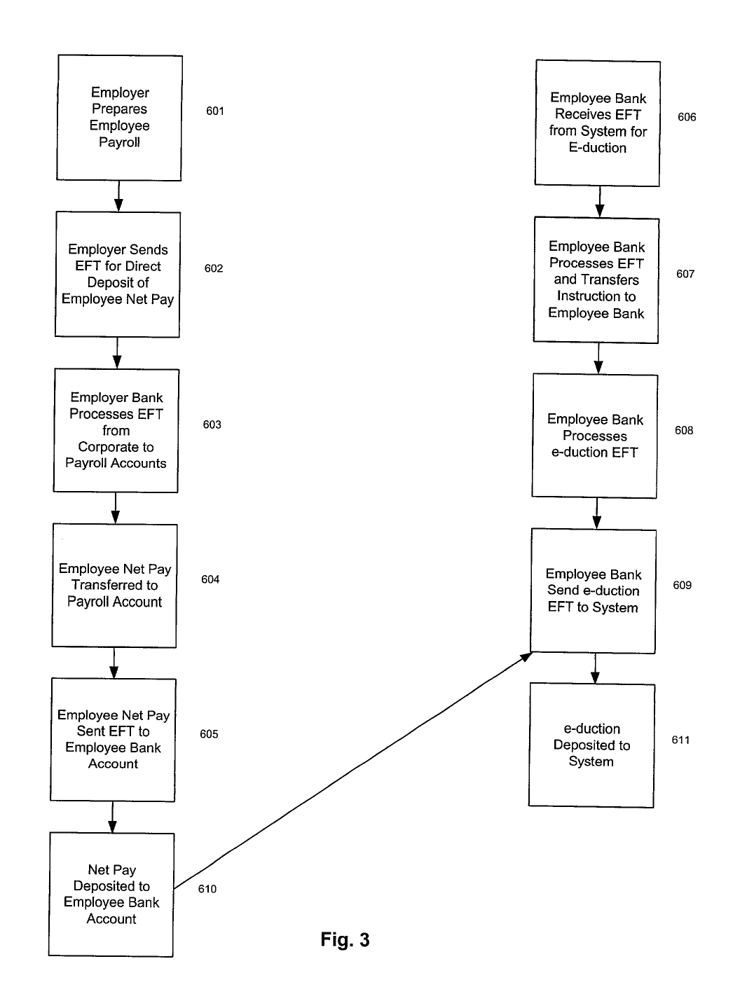

In an alternate embodiment of the present invention, the employee deductions for e-duction purchase payments are not taken directly from the employer's payroll account, but instead are transferred through an electronic funds transfer (EFT), such as an Automated Clearinghouse System (ACH). As shown in FIG. 3, the employer prepares the employee payroll entry, which includes the gross pay amount and the net pay amount at step 601. At step 602 the employer sends EFT instructions to directly deposit the employee net pay to the employee's personal bank account. At step 603, the employer's bank receives and processes the employer instructions for an EFT from the employer bank to the employee's bank account. For example, the employer may have both a corporate account and an employer payroll account from which the employees are to receive their pay. The employer's bank may receive and process the instruction for an EFT from the corporate account to the payroll count. Then the employee net pay is transferred to the employer payroll account at step 604, and from the payroll account the net pay is sent EFT to the employee's personal bank account at step 605. It will be apparent to one skilled in the art that the payroll funds can be processed and transferred from any type of employer account to any type of employee account.

The employee bank receives EFT instructions from the employer payroll account and deposits the net pay at step 610. At the same time, however, an EFT of the employee's e-duction purchase deduction amount are sent from the employee bank account to the e-duction card issuer's bank account at step 606. The EFT instructions are received and processed at the employee bank and transferred to the employee's personal bank account at step 607. The employee's personal bank account receives and processes this EFT instruction from the inventive system's bank in the amount of the deduction at step 608. The employee's personal bank account thus sends the deduction EFT to the inventive system's bank at step 609, which is received and deposited at the inventive systems' bank at step 610.

For example, the employee's gross pay is $500 and net pay is $350. During the pay period, the employee makes a purchase, using the e-duction card, of an amount of $100. The e-duction payment is set at $50 per pay period for two pay periods. The employer sends an EFT instruction for a $350 (net pay) direct deposit to the employee's personal bank. The EFT instruction is received and processed for the $350 from the employer's payroll account, and the $350 is transferred from the employer corporate account to the payroll account. The employer payroll account sends $350 to be direct deposited into the employee's personal bank account. That account receives and processes the EFT and thus $350 is deposited into the employee's personal bank account. The inventive system, at the same time, sends EFT instructions to have $50 transferred from the employee personal bank account to the inventive system's bank. This instruction is received and processed at the inventive system bank and sent to the employee's personal bank account. After receiving and processing this EFT instruction, the employee's bank sends $50 e-duction payment EFT to the e-duction card issuer's bank to be deposited.

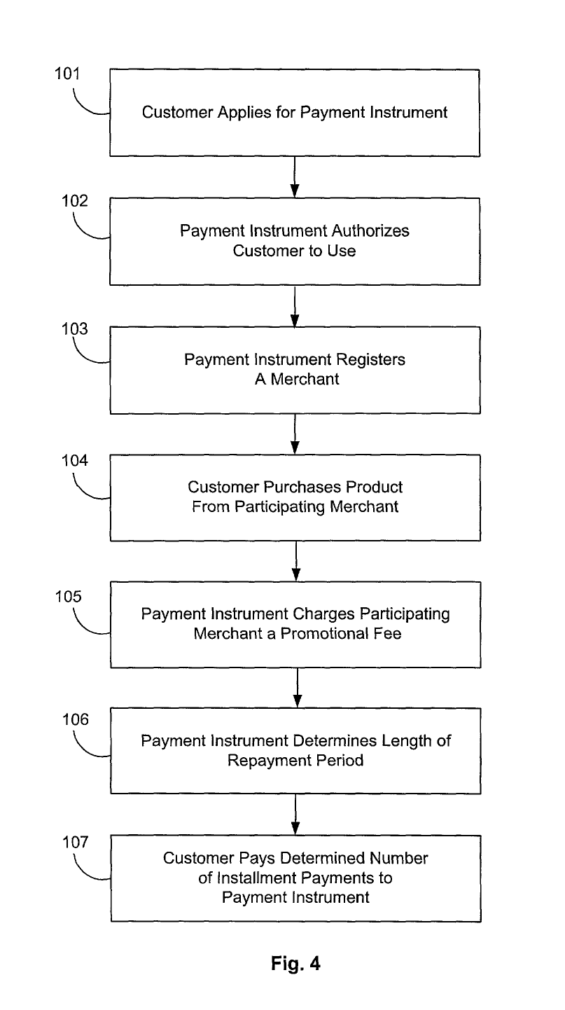

FIG. 4 illustrates the steps implemented for financing a payroll deduction plan according to a preferred embodiment of the inventive method. In step 101 a customer applies for payroll deduction and an e-duction card, as described above, or applies for another type of payment instrument. A payment instrument, such as Visa® or American Express® is, for example, a credit card issued from a financial institution. Other types of payment instruments will be known to those skilled in the art and are within the scope of this invention. Hereinafter both the e-duction card and other payment instruments collectively will be referred to as “payment instruments.”

In step 102, the payment instrument authorizes the customer to use the payment instrument during commerce. The authorization includes verification of the information entered by the customer. The authorization also may include a determination of a credit limit for the customer.

The inventive system is not limited to new customers. For example, a customer may already have a Visa® card that is linked to the inventive system at a later date. Thus, the application and authorization occurred when the customer originally applied for the payment instrument. Thus, participation in the inventive system appears seamless to the customer. Step 103 illustrates registering, by the payment instrument, a merchant as a participating merchant. The merchant may have a web site, be a brick and mortar store, a catalog, a seller of services, and/or any other type of business known to those skilled in the art. The participating merchant and payment instrument agree to certain terms and conditions during the registration process. For example, the participating merchant may agree to accept the payment instrument for purchases made at its business, the payment of a discount fee to the payment instrument, and the payment to the payment instrument of a promotional fee, which will be discussed later. The discount fee is a typical fee that the payment instrument and the merchant may negotiate. Of course, a third party also may negotiate the promotional fee as well. Other terms and conditions will be known to those skilled in the art and are within the scope of the present invention.

In step 104, the customer purchases a product from the participating merchant, and uses the payment instrument to pay for the product. A customer may actually purchase a product directly from a brick and mortar participating merchant, may purchase a product from an on-line participating merchant site, or may purchase a product over the telephone, by mail or catalog. Other methods of purchasing will be known to those skilled in the art and are within the scope of the invention.

In step 105, the payment instrument charges the participating merchant a promotional fee. The promotional fee may be a percentage of the product price. For example, a participating merchant may agree to pay the payment instrument 5% of the price of anything purchased using the payment instrument. The promotional fee also may vary depending on what is purchased, the length of time being offered to the customer for interest free payments, or other schemes known to those skilled in the art. Generally, this promotional fee is charged monthly. The timing of the promotional fee payment also may be negotiated between the payment instrument and the participating merchant. For example the promotional fee may be charged on a daily, or weekly basis.

In step 106, the payment instrument determines a number of installment payment periods over which the customer may pay for the purchased product without incurring interest. For example, the payment instrument may allow a customer to make payments for six months, interest free. The period of time in which to make the payments may vary, depending upon the customer, the authorized credit limit, and the purchase price of the product. Other factors will be known to those skilled in the art and are within the scope of the present invention.

The determining step also may include a determination that the purchase actually is within the available credit limit established for the particular authorized customer. If the purchase is less than available credit, the payment instrument approves the transaction. Moreover, if the customer has applied for an overdraft account and the purchase is over the credit limit, the payment instrument may also approve the transaction. The extra amount of the purchase price beyond the credit limit automatically will be charged to the overdraft account. The maximum amount of the credit limit is calculated to be paid over the determined payment period without interest charges. The amount over the credit limit that is charged to the overdraft account is paid by the customer as a regular interest bearing credit card account. This amount may be automatically deducted from the customer's payroll at minimum payment terms as determined by the payment instrument, paid by check or however the payment instrument determines.

The determining step may be performed using the payment instrument's network infrastructure. This infrastructure may include a credit card reader, for example, that is connected to any type of network, such as a local area network (LAN), Wide Area Network (WAN), the Internet, or any other known to those skilled in the art. For example, the payment instrument may be represented by a credit card having a magnetic stripe on which is stored the authorized customer name and/or account number. When the credit card is swiped into the network infrastructure at the participating merchant location during a purchase, the account number and customer name are transmitted to a network processor via the network infrastructure. Another embodiment includes having a customer input its account number into the payment instrument's web site, wherein the network infrastructure transmits the information over the Internet. The network processor may be a computer or any other device known to those skilled in the art. The network processor uses that information to verify the customer's authorization to use the payment instrument, the credit limit, and that the merchant is a participating merchant. Other methods of determining customer's authorization will be known to those skilled in the art and are within the scope of this invention.

The network processor also may determine the minimum payment for the customer, and may initiate the payment of the merchant discount fee and the payment of the promotional fee, as discussed above. The network processor also may automatically update and determine any changes in the customer's payment schedule as the customer purchases further products, as discussed in more detail above. It is important to note that the inventive system allows the customer unlimited use (within any credit limit that may be in place) of the payment instrument. Thus, the system is not limited to certain products, certain times in which to make purchases, or certain purchase prices. The payment instrument allows a much broader base of use than the prior art methods. Moreover, the use of the payment instrument is recurring, exactly like a standard credit or debit card.

Step 107 shows the customer paying the number of installment payments to the payment instrument. The payment may be made by having the customer write a check payable to the payment instrument for each installment. Alternatively, the payment instrument may automatically deduct, from the customer's bank account, the payment for each installment. Another embodiment would have each installment payment be automatically deducted from the customer's paycheck as described above in detail.

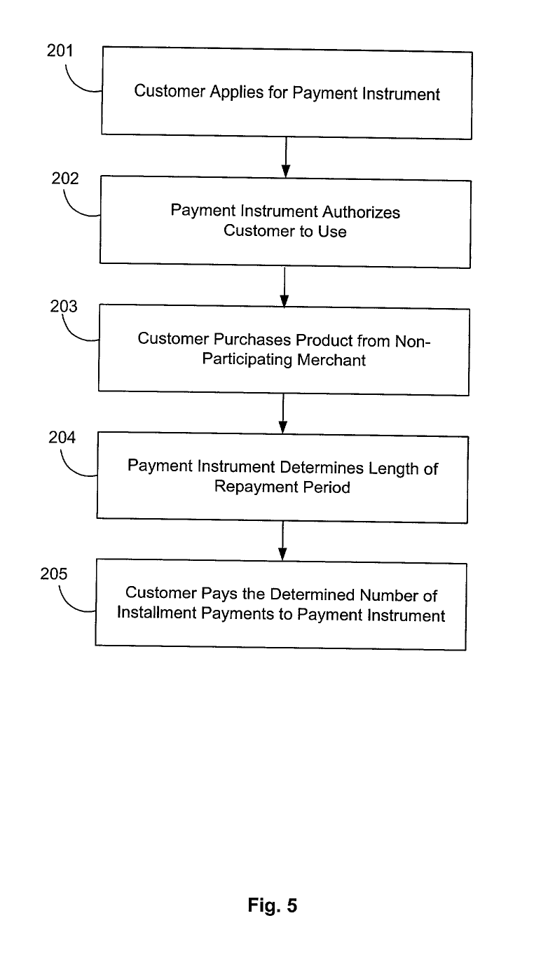

In another embodiment of the present invention shown in FIG. 5, the customer applies for a payment instrument at 201, and the payment instrument authorizes the customer to use the payment instrument during commerce at 202. The customer then purchases a product using the payment instrument at a non-participating merchant, i.e., a merchant who does not have any type of agreement with the payment instrument at 203. In this scenario, the length of repayment period over which a customer may pay for the purchased product without incurring interest is determined by the payment instrument; and preferably the installment period is set at two months, regardless of the purchase amount or merchant. The typical credit card has an average receivables cycle of 45 to 55 days. If the payment instrument allows the customer a two-month window in which to repay a purchase, this cycle is not greatly affected, if at all. Of course, the set time period can be varied, depending upon the payment instrument's business strategy.

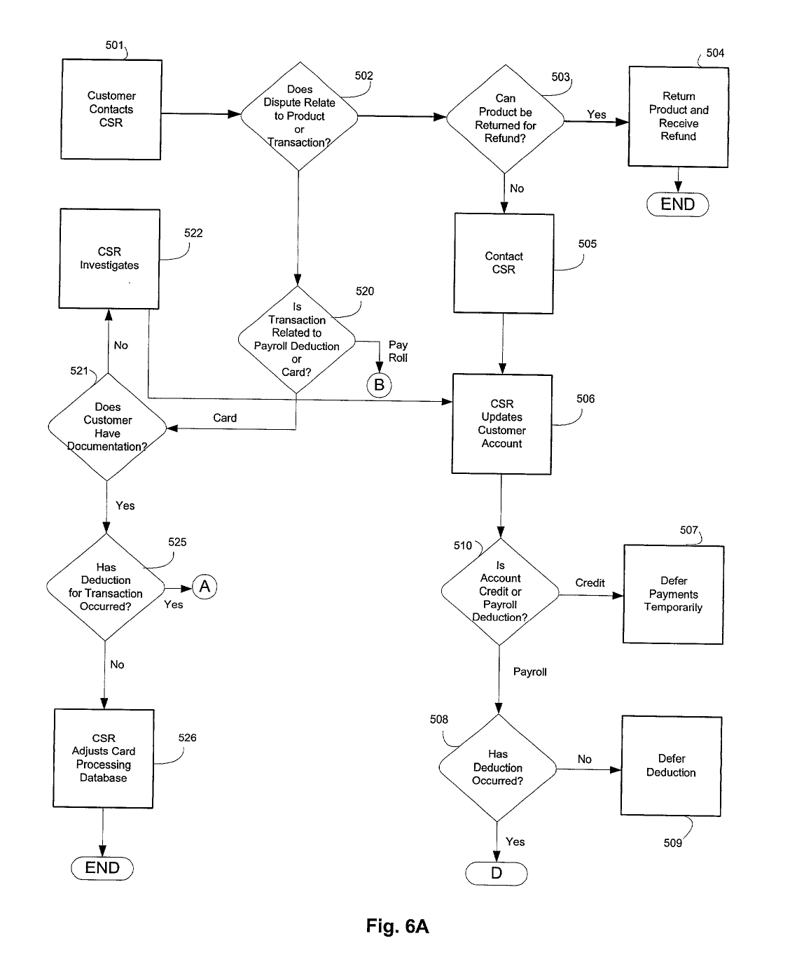

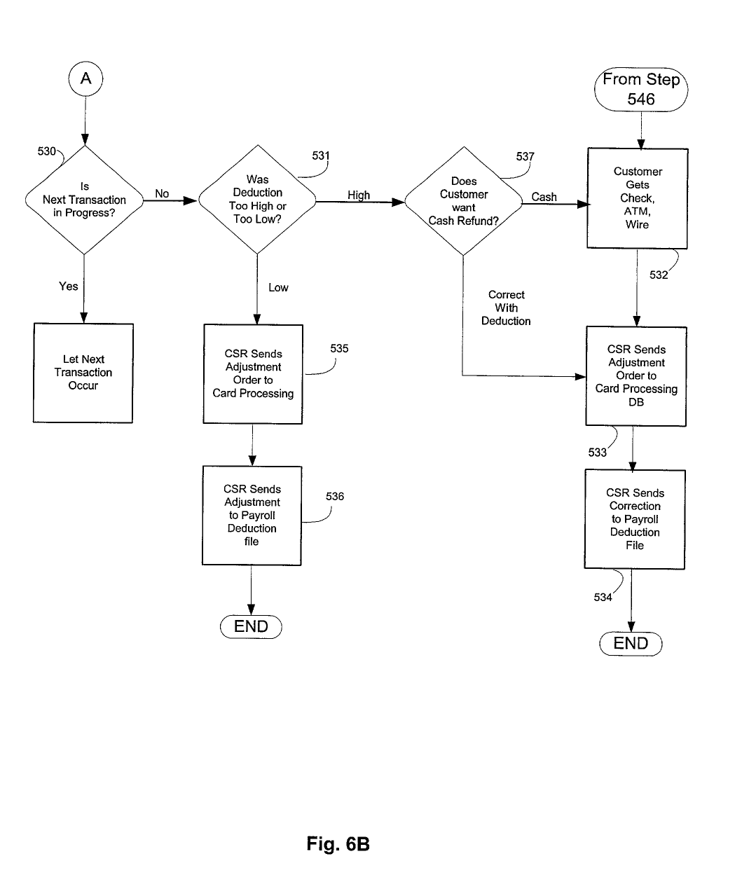

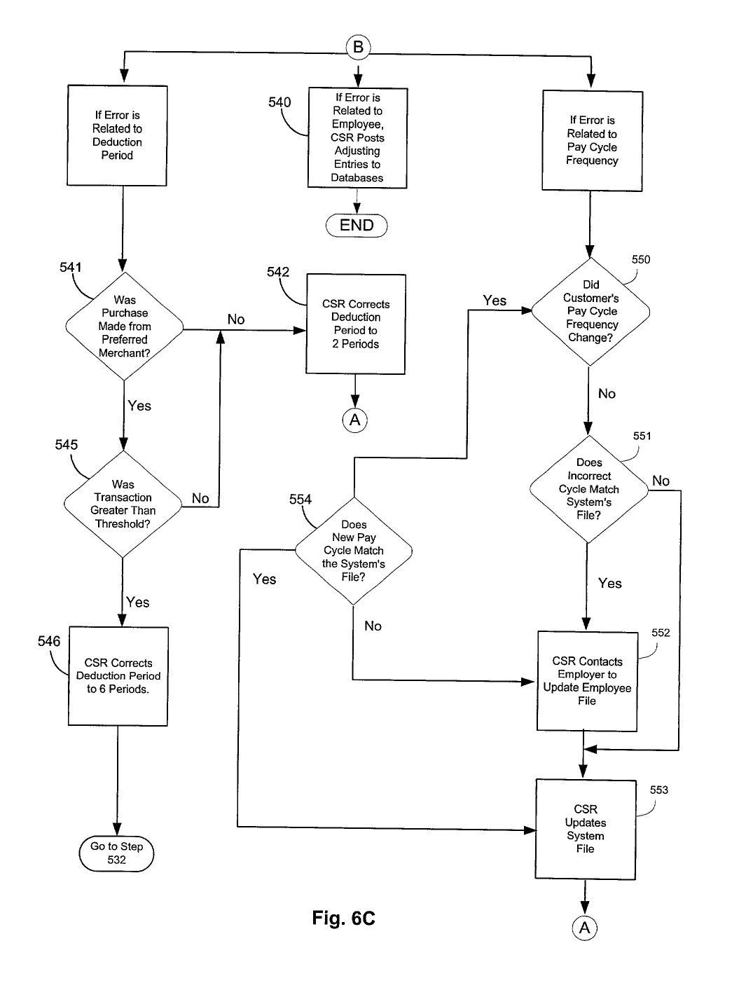

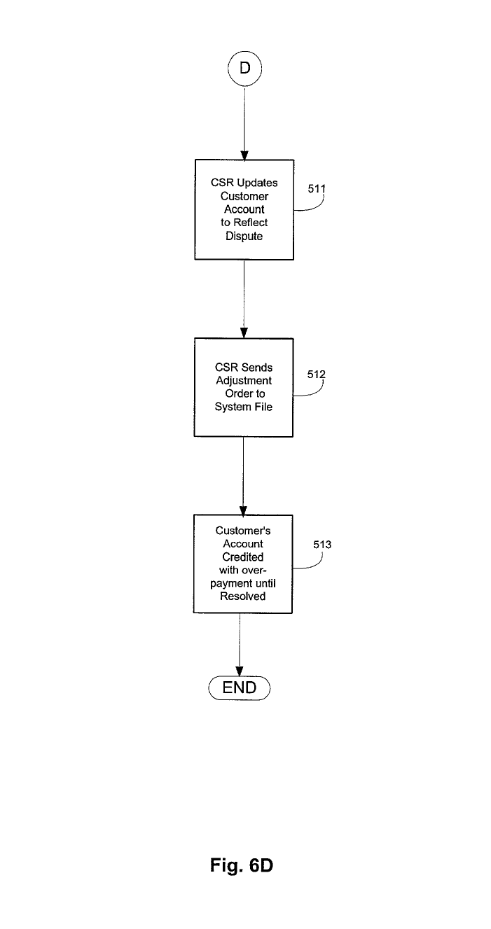

Another aspect of the present invention is a method of resolving disputes a customer may have regarding a product purchased, the installment payments, or other transaction processings. FIG. 6 illustrates the steps implemented in a dispute resolution according to a preferred embodiment of the inventive method. As shown in step 501 the customer contacts a customer service representative of the payment instrument to register a dispute. The first decision that must be made is whether the dispute relates to the processing of a transaction or to a product purchased or service rendered, in step 502. If the problem relates to a product or a service, a determination is made at step 503 as to whether the customer can return the product or get a refund for the incomplete service. If so, the process is terminated upon the return of the product or partial refund, at step 504. If the merchant refuses to accept the return of product or refuses to refund money for services not rendered, the customer again contacts the service representative at step 505. The representative updates the customer's account in the network processor to reflect that a charge is in dispute, in step 506 (the customer's credit availability is not updated until the dispute is resolved). This update will result in a number of options. If the account is on a credit line for which interest is normally charged (the determination is made at step 510), the interest is temporarily deferred, in step 507. If the account is a payroll deduction account (determined at step 510) a determination is made as to whether a deduction from the customer's paycheck for the disputed purchase has occurred in step 508. If not, and the next pay cycle is not in progress yet, the customer service representative is able to post an entry on the network processing system to defer all disputed deductions at step 509. The parties are then free to resolve the issue. If the customer is ultimately successful, the credit availability is restored. If the customer ultimately loses the dispute, all deduction adjustments that were made must be reversed, and normal payroll deductions are initiated and the network processing system database is updated accordingly.

If, on the other hand, the payroll deduction has occurred, or is in progress, the representative updates the customer's account in the network processor to reflect that a charge is in dispute, in step 511, which will defer interest (if it is a credit line for which interest is normally charged). The representative also sends an adjustment order to the payroll deduction file to decrease future deductions to correct for the over-deduction of the disputed amount at step 512. If the deduction error correction is more than the next deduction amount, the future deductions are eliminated until all repayment is reduced to zero, and the customer's account is credited with the overpayment, at step 513 until the dispute is resolved. If the customer ultimately loses the dispute, all deduction adjustments that were made must be reversed, and normal payroll deductions are initiated and the network processing system database is updated accordingly.

Going back to the first determination in this process at step 502, if the customer's dispute relates to transaction processing, the next step is to determine if the transaction relates to a payroll deduction or to a card purchase at step 520. Typical disputes relating to a card purchase are, for example, that there is a duplicate transaction posted to the customer's account, a missing transaction, the amount of transaction is incorrect, or a return/credit transaction is incorrectly posted on the account. If any of the above situations exist, a determination must be made as to whether the customer has documentation relating to the disputed transaction at step 521. If not, the customer service representative must investigate the transaction and resolve the dispute at step 522. If the investigation takes a long time, the service representative may update the customer's account in the network processor to reflect that a charge is in dispute, as described above at steps 506 to 513. If the customer ultimately loses the dispute, all deduction adjustments that were made must be reversed.

If, on the other hand, the customer has documentation related to the disputed card transaction, a determination is made as to whether a deduction for the card transaction (either a payroll deduction or bank draft) has occurred or is in progress, in step 525. If neither has occurred, the customer service representative makes an adjustment entry in the card processing database to correct the deduction amount and to correct any credit limit information, at step 526.

If an incorrect deduction from the customer's paycheck or bank account has been made for the card transaction, a determination must be made as to whether the next deduction cycle is in progress, at step 530. If it is not, the system determines whether the deduction in dispute was too high or too low at step 531. A deduction is too high when, for example, a customer makes a purchase for $100.00, and instead of deducting $25.00 from the next 4 customer pay checks, the purchase is posted as $1,000.00 and a deduction of $250.00 is deducted from the customer's paycheck in the first pay period. The customer has the choice of receiving a refund of the extra $225.00 immediately or having future payroll deductions adjusted to reflect a credit of $225.00. If the customer wants immediate cash, determined at step 537, the service representative sends the customer a refund check, wire transfers the refund to the customer's bank account, or makes the cash available at any ATM machine that the customer accesses with the e-duction or credit card, at step 532. In addition, the service representative sends an adjustment order to the card processing database to correct the transaction amount and to adjust the credit limit for the customer, at step 533. The network processing system file also is corrected by the service representative to decrease future deductions to the correct $25.00 deduction a period, at step 534.

If the customer prefers to have the future deductions adjusted to correct the previous deduction error, the service representative sends an adjustment order to the network processing system to correct the transaction amount and sends an notice to the card processing database to adjust the credit limit for the customer, at step 533. The network processing system also is corrected by the service representative to decrease future deductions to the correct $25.00 deduction a period at step 534. If the deduction error correction is more than the next deduction amount (which in the example given it is) the future deductions are eliminated until all repayment is reduced to zero, and the customer's account is credited with the overpayment.

Going back to the determination of over-versus-under deduction error (at step 531)—if the deduction was too low (for example a $1,000.00 purchase is posted as a $100.00 purchase), the service representative posts an adjusting entry on the processing system at step 535. This posting will decrease the customer's credit availability. The service representative also posts an adjusting entry to reflect the larger purchase, which increases further deductions to eliminate the under-deduction and adjust for past under-deductions at step 536. This adjustment can happen a number of ways.

For example, a $200.00 purchase is incorrectly posted as $20.00. Thus, the customer's deduction for the first cycle is incorrectly set at $5.00 (the deductions are set to be made over 4 bi-weekly or semi-monthly pay periods). In one embodiment, the deduction is adjusted such that the $45.00 under-deduction amount is added to the immediate next period, for an overall deduction of $95.00. The next two periods are adjusted to be $50.00. In another embodiment, an additional period is added in which the $45.00 under-deduction amount is deducted from the customer's pay (thus, in all, the customer has monies deducted for 5 periods equaling $5.00, $50.00, $50.00, $50.00, $45.00). In yet another embodiment, the $45.00 under-amount is split equally over the remaining deduction periods. Thus, the customer has $65.00 deducted for three pay periods.

Of course, if the adjustment for the past under-deduction is greater than the customer's payroll net pay amount, the next payroll or bank deduction is increased to the net pay amount and the balance is adjusted to the next deduction cycle(s).

Returning to step 530, if it is determined that the next deduction period has begun its process, the customer service representative performs the steps 531-1537 described above, with the exception that all deduction adjustments and refunds take place in the period occurring after the deduction period in progress.

Returning to step 520, it is determined that the dispute is related to a payroll deduction. The types of disputes that may arise are that the deduction is posted to the wrong employee, that the deductions should occur for x pay periods but instead are occurring for y periods, or that the deductions are being deducted on the incorrect payroll cycle frequency. If the wrong employee has had an amount deducted, the customer service representative posts adjusting entries to have deductions begin for the correct employee, to have deductions to the disputing employee cease or be adjusted to reflect the elimination of the incorrect deduction and to adjust the credit limits of both the correct and incorrect employee, at step 540.

If the dispute relates to the deduction period, the determination must be made as to whether the deduction relates to a preferred merchant at step 541. If the purchase was made from a merchant who is not a preferred merchant, the deduction period is corrected to be 2 months at step 542. As discussed above, the two-month period can be interest free. The customer service representative next determines if the payroll deduction cycle is in progress at step 530. If it is not, the method follows steps 531-537 above. If the cycle is in progress, the method follows the same steps with all adjustments being made after the deduction period in progress is completed.

If the purchase was made from a preferred merchant, a determination must be made as to whether the transaction is more than a threshold amount at step 545. This threshold amount is what determines the length of repayment periods. Transactions that are above the threshold might qualify for extended repayment periods and transactions below the threshold might be repaid at the standard term. For example, a threshold amount could be set at $400. If a purchase from a preferred merchant is for less than that amount, the length of the repayment from which monies are deducted is normally set at two months. If the amount is more than $400, the length of repayment is normally set at six months. Thus, if it is determined that the purchase price in dispute was for less than $400, the service representative adjusts the repayment period to be 2 months at step 542. Of course, the service representative must determine if the next payroll deduction cycle is in process at step 530. If so, steps 531-537 given above are followed and if not, steps 531-537 given above are followed with all adjustments being made after the deduction period in progress is completed.

On the other hand, if the purchase amount was over the threshold amount and the deductions were incorrectly set at 2 periods, an over-deduction has occurred (e.g., the purchase was for $600 and $300 was deducted from the first pay period instead of $100). The service representative must adjust the repayment period from two months to six months at step 546. Moreover, the customer may be reimbursed with cash or with credit against subsequent deductions, as described in step 532 given above.

Another type of error that may occur is that the pay cycle frequency logic is incorrect. For example, a customer may get paid weekly, bi-weekly, or monthly. If the payroll deduction reflects an incorrect logic in the frequency with which the deductions are to be made, a determination must be made as to whether the customer's actual pay cycle frequency changed since registering with the inventive system at step 550. If not, a determination must be made as to whether the incorrect pay cycle matches the cycle given in the inventive system's file at step 551. If the error does not match, the customer service representative contacts the employer with information on updating the employee's file to correct the pay cycle frequency at step 552. If the pay cycle frequency with which the deduction is being made matches that given in the inventive system's file, an error exists within the system's database, and the database must be updated to the correct pay period frequency at step 552. Once the correct information is input to the system, a determination must be made as to whether the next payroll deduction cycle is in progress at step 530. If it is not, steps 531-537 given above must be followed to insure the customer is refunded and the correct payments are made. If the next cycle is in progress, the same steps are followed after the cycle in progress is completed to correct the payments and make the customer whole.

Going back to step 550, if it is determined that the customer's pay cycle frequency actually did change, a determination must be made as to whether the new pay cycle matches the cycle in the inventive system's file at step 554. If the cycles do not match, the system's database must be updated at step 553, and the method again returns to step 530 to determine if the next payroll deduction cycle is in progress, etc.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A method for selecting and processing account deductions as a payment option between pre-selected vendors and an employee of an employer, the method comprising the steps of:
authorizing, by the employee, an external processing system to perform account deductions as a payment option during commerce between the pre-selected vendors and the employee;
establishing, by the external processing system and the employer, guidelines for an account deduction plan;
storing the guidelines in the external processing system database;
selecting, by the employee, articles to be purchased from at least one of the pre-selected vendors;
storing, by the external processing system into the database, at least one electronic order of the articles to be purchased;
sending, by the employer, instructions to deposit the employee's pay into an account for the employee; and
dynamically processing, by the external processing system, instructions to the employee's account to transfer a payment amount to the external processing system based upon the at least one electronic order and the guidelines.

2. The method of claim 1, wherein the step of establishing guidelines further comprises the steps of:
establishing the length of a repayment period during which account deductions can occur;
establishing an available credit allowed to each employee; and
basing the length of the repayment period on an order balance amount.

3. The method of claim 2, wherein the step of establishing guidelines further comprises the steps of:
authorizing the pre-selected vendors to offer interest free account deductions up to a predefined time for payments over a certain amount; and;
authorizing the external processing system to automatically deduct monthly payments from employees that are authorized to use account deduction for such transactions.

4. The method of claim 3, wherein the step of establishing guidelines further comprises the step of establishing several sets of guidelines, whereby each set of guidelines is associated with employees within a particular status.

5. The method of claim 1, further comprising the steps of periodically providing, to the external processing system by the employer, a list with information about employees who qualify to participate to use the account deduction plan, and storing, by the external processing system, the list with information in a system database.

6. The method of claim 1, wherein the step of selecting articles further comprises the step of selecting articles from the pre-selected vendors' web sites, stores, catalogs or telemarketing campaigns.

7. The method of claim 1 wherein the instructions authorize an Electronic Funds Transfer (EFT).

8. A method for allowing an employee of an employer to place an order with a plurality of vendors, comprising:
(a) establishing guidelines for an account deduction plan by an external processing system and the employer, wherein the account deduction plan allows qualified employees of the employer to automatically pay for orders placed with any of the plurality of vendors using the account deduction plan
(b) receiving electronically, at the external processing system, order information from one of the plurality of vendors with whom a purchasing employee wishes to place an order;
(c) determining electronically by the external processing system, in response to the order information and in accordance with the account deduction plan guidelines and the qualification information, whether to automatically approve or reject the order; and
(d) if the order is approved, electronically processing by the external processing system, instructions to the employee's account to transfer a payment amount to the vendor based upon the one electronic order and the guidelines.

9. The method of claim 8, wherein the step of establishing guidelines further comprises the steps of:
establishing the length of the repayment period during which account deductions can occur;
establishing an available credit allowed to each employee; and
basing the number of account deductions on an order balance amount.

10. The method of claim 8 further comprising the step of periodically electronically receiving at the external processing system, from the employer, qualification information for employees of the employer who are qualified to participate in the account deduction plan.

11. The method of claim 10, wherein the step of establishing guidelines further comprises the steps of:
authorizing the vendors to offer interest free account deductions up to a predefined time for payments over a certain amount; and;
authorizing the external processing system to automatically deduct monthly payments from employees that are authorized to use account deduction for such transactions.

12. The method of claim 11, wherein the step of establishing guidelines further comprises the step of establishing several sets of guidelines, whereby each set of guidelines is associated with employees within a particular status.

13. The method of claim 8, further comprising the steps of periodically providing to the external processing system, by the employer, a list with information about employees who qualify to participate to use the account deduction plan, and storing, by the external processing system, the list with information in a system database.

14. The method of claim 8, further comprising the step of periodically electronically receiving at the external processing system, from the employer, qualification information for employees of the employer who are qualified to participate in the account deduction plan.

15. The method of claim 8 wherein the instructions are ACH.

16. The method of claim 9, wherein the step of selecting articles further comprises the step of selecting articles from the pre-selected vendors' web sites, stores, catalogs or telemarketing campaigns.

17. A method of dynamically resolving disputes between an employee using a payroll deduction plan to pay for purchases and an external system processing the payroll deduction plan, the method comprising the steps of:
(a) determining if the dispute relates to a product or service purchased from a merchant or to an error in the processed employee payroll deduction;
(b) if the dispute relates to an error in the processed employee payroll deduction, determining if the error is related to a number of deduction periods or the employee's pay cycle frequency;
(c) if the error relates to an error in the number of deduction periods, the external system corrects the number of deduction periods and determines if a next payroll deduction period is in progress of being processed;
(d) if the external system determines that a deduction period is in progress, the external system allows the next deduction to occur and determines if the deduction amount is too high or too low;
(e) if the deduction amount is too low, the employee payroll deduction amounts are increased per deduction period;
(f) if the deduction amount is too high, the external system allows the employee to choose to immediately receive a cash refund or to have future payroll deduction amounts adjusted; and
(g) if the dispute relates to an error in the employee's pay cycle frequency, the external processing system updates and corrects the employee pay cycle frequency in the payroll deduction plan and determines if the next payroll deduction period is in progress and if so, performs steps (d) through (f).

18. The method of claim 17 wherein if the dispute relates to a product purchased, the method further comprises the steps of determining if a next payroll deduction relating to the product occurred, and if so, performing steps (d) through (f).

19. The method of claim 17 wherein the cash refund may be a check, cash from an ATM, or wired cash.

20. The method claim 17 wherein if the dispute relates to the deduction period, a determination is made whether the purchase was made from a preferred merchant, and if so, further comprising the steps of:
(g) determining if the purchase amount exceeded a predetermined threshold amount;
(h) if so, correcting the length of the repayment period to be six; and
(i) if the purchase amount did not exceed the threshold amount, correcting the length of the repayment period to be two, and performing steps (d) through (f).

21. The method of claim 20, wherein if the length of the repayment period is corrected to be six in step (i), further comprising the step of having the external system allow the employee to choose to immediately receive a cash refund or to have future payroll deduction amounts adjusted.

22. A method for selecting and processing account deductions as a payment option between a plurality of vendors and an employee of an employer, the method comprising the steps of:
authorizing, by the employee, an external processing system to perform account deductions as a payment option during commerce between the plurality of vendors and the employee;
establishing, by the external processing system and the employer, guidelines for an account deduction plan;
storing the guidelines in the external processing system database;
selecting, by the employee, articles to be purchased from at least one of the plurality of vendors;
storing, by the external processing system into the database, at least one electronic order of the articles to be purchased;
sending, by the employer, instructions to deposit the employee's pay into an account for the employee; and
dynamically processing, by the external processing system, instructions to the employee's account to transfer a payment amount to the external processing system based upon the at least one electronic order and the guidelines.

23. The method of claim 22, wherein the step of establishing guidelines further comprises the steps of:
establishing a number of pay periods during which account deductions can occur;
establishing an available credit allowed to each employee; and
basing the length of the repayment period on an order balance amount.

24. The method of claim 23 further comprising the step of periodically electronically receiving at an external processing system, from the employer, qualification information for employees of the employer who are qualified to participate in the account deduction plan.

25. A method of dynamically resolving disputes between an employee using a payroll deduction plan to pay for purchases and an external system processing the payroll deduction plan, the method comprising the steps of:
(a) determining if the dispute relates to a merchant purchase or to an error in the transaction processing;
(b) if the dispute relates to a merchant purchase, determining if the dispute is related to a product or to delivery of a service;
(c) if the dispute relates to a product, determining if the product was returned to the merchant, and if so, determining if the merchant refused to accept the returned product or otherwise provide relief to the employee;
(d) if the dispute relates to a service, determining if the service was fully received by the employee, and if not, determining a partial refund to the employee is possible, and if so, determining if the merchant refused to provide a partial refund or otherwise provide relief to the Employee;
(e) if the dispute relates to an error in transaction processing, determining if the error is related to merchant and/or card processor posting of the transaction or if the error is related to automatic deductions executed by the external system;
(f) if the dispute relates to merchant and/or card processor posting of the transaction, determining if the employee has documentation to support the dispute;
(g) if the dispute relates to an error in the automatic deductions executed by the external system, determining if the dispute relates to an automatic payroll deduction from an incorrect employee, an error in a repayment period, an error in payroll cycle frequency, or an error in a total amount deducted for a single transaction;
(h) if the dispute relates to steps (c) through (g) above, determining if automatic payroll deductions have already occurred, or if not, determining if automatic payroll deductions are already in process;
(i) if automatic deductions in (h) above have already occurred or are in the process of occurring, and if the dispute relates to steps (f) and (g), determining if the transaction processing error resulted in an automatic payroll deduction more than or less than a correct amount;
(j) if the dispute relates to steps (c) and (d), or if the automatic deduction in step (i) is determined to be more than the correct amount, correcting the automatic payroll deduction;
(k) if the dispute relates to step (i) and the automatic payroll deduction is more than the correct amount, allowing the employee to choose to have immediate reimbursement;
(l) if the automatic payroll deduction in step (i) is less than the correct amount, correcting future the automatic payroll deductions by extending a repayment period;
(m) deferring all future automatic payroll deductions until the dispute is finally resolved;
(n) if the dispute is finally resolved in the employee's favor, eliminating all future automatic payroll deductions entirely; and
(o) if the dispute is partially resolved in the employee's favor or if the dispute is resolved in the external system's favor, reinstating all remaining automatic payroll deductions as scheduled and recovering deducted amounts that were reimbursed to the employee in steps (j) and (k).

26. The method of claim 25 wherein step (k) further comprises the step of reimbursing the employee by reducing or eliminating future automatic payroll deductions.

27. The method of claim 25 wherein step (o) further comprises the step of recovering services fees by the external system.
